(19) United States
(12) Patent Application Publication
(10) Pub. No.: US 2016/0344322 A1
(43) Pub. Date: Nov. 24, 2016

(54) MOTOR, MOTOR DRIVING CIRCUIT AND INTEGRATED CIRCUIT FOR DRIVING MOTOR

(71) Applicant: Johnson Electric S.A., Murten (CH)

(72) Inventors: Chi Ping SUN, Hong Kong (CN); Fei XIN, Shen Zhen (CN); Shing Hin YEUNG, Hong Kong (CN); Ken WONG, Hong Kong (CN); Shu Juan HUANG, Shen Zhen (CN); Yun Long JIANG, Shen Zhen (CN); Yue LI, Hong Kong (CN); Bao Ting LIU, Shen Zhen (CN); En Hui WANG, Shen Zhen (CN); Xiu Wen YANG, Shen Zhen (CN); Li Sheng LIU, Shen Zhen (CN); Yan Yun CUI, Shen Zhen (CN)

(21) Appl. No.: 15/231,109

(22) Filed: Aug. 8, 2016

Related U.S. Application Data
(63) Continuation-in-part of application No. 14/822,353, filed on Aug. 10, 2015.
Application No. 14/822,353 is a continuation of application No. PCT/CN15/86422, filed on Aug. 7, 2015.

(30) Foreign Application Priority Data
Aug. 8, 2014 (CN) 201410390592.2
Aug. 15, 2014 (CN) 201410404474.2
Jul. 6, 2016 (CN) 201610527483.X

(51) Int. Cl. H02P 6/16; H02P 6/26; H02K 21/00; H02K 1/27; H02K 11/215

(52) U.S. Cl. CPC H02P 6/16; H02K 1/2706; H02K 11/215; H02K 21/00; H02P 6/26

(57) ABSTRACT

A motor driving circuit drives a motor. The motor driving circuit comprises a controllable bidirectional alternate current switch, a detection circuit. The controllable bidirectional alternate current switch is connected in series to a winding of the motor between two terminals of an alternate current power supply. The detection circuit is configured to detect a magnetic pole position of a rotor of the motor and output a magnetic pole position signal. And a switch state of the controllable bidirectional alternate current switch is controlled to determine a rotation direction of the motor according to a control signal and polarity of the alternate power supply.

### CROSS REFERENCE TO RELATED APPLICATIONS

This application is a continuation-in-part of co-pending U.S. patent application Ser. No. 14/822,353, filed on Aug. 10, 2015, which claims priority under 35 U.S.C. §119(a) from Patent Application No. 201410390592.2 filed in the People's Republic of China on Aug. 8, 2014, and Patent Application No. 201410404474.2 filed in the People's Republic of China on Aug. 15, 2014. In addition, this application claims priority under 35 U.S.C. §119(a) from Patent Application No. PCTCN2015086422 as PCT application filed in Receiving Office of CN on Aug. 7, 2015, to Chinese Patent Application No. CN201610527483.X, filed with the Chinese Patent Office on Jul. 6, 2016, all of which are expressly incorporated herein by reference in their entireties and for all purposes.

### FIELD

The present disclosure relates to a field of motor control, and in particular to a motor, and a motor driving circuit and an integrated circuit for driving a motor.

### BACKGROUND

During starting of a synchronous motor, the stator produces an alternating magnetic field causing the permanent magnetic rotor to be oscillated. The amplitude of the oscillation of the rotor increases until the rotor begins to rotate, and finally the rotor is accelerated to rotate in synchronism with the alternating magnetic field of the stator. To ensure the starting of a conventional synchronous motor, a starting point of the motor is set to be low, which results in that the motor cannot operate at a relatively high working point, thus the efficiency is low. In another aspect, the rotor cannot be ensured to rotate in a same direction every time since a stop or stationary position of the permanent magnetic rotor is not fixed. Accordingly, in applications such as a fan and water pump, the impeller driven by the rotor has straight radial vanes, which results in a low operational efficiency of the fan and water pump.

FIG. 1 illustrates a conventional drive circuit for a synchronous motor, which allows a rotor to rotate in a same predetermined direction in every time it starts. In the circuit, a stator winding 1 of the motor is connected in series with a TRIAC between two terminals M and N of an AC power source VM, and an AC power source VM is converted by a conversion circuit DC into a direct current voltage and the direct current is supplied to a position sensor H. A magnetic pole position of a rotor in the motor is detected by the position sensor H, and an output signal Vh of the position sensor H is connected to a switch control circuit PC to control the bidirectional thyristor T.

FIG. 2 illustrates a waveform of the drive circuit. It can be seen from FIG. 2 that, in the drive circuit, no matter the bidirectional thyristor T is switched on or off, the AC power source supplies power for the conversion circuit DC so that the conversion circuit DC constantly outputs and supplies power for the position sensor H (referring to a signal VH in FIG. 2). In a low-power application, in a case that the AC power source is commercial electricity of about 200V, the electric energy consumed by two resistors R2 and R3 in the conversion circuit DC is more than the electric energy consumed by the motor.

The magnetic sensor applies Hall effect, in which, when current I runs through a substance and a magnetic field B is applied in a positive angle with respect to the current I, a potential difference V is generated in a direction perpendicular to the direction of current I and the direction of the magnetic field B. The magnetic sensor is often implemented to detect the magnetic polarity of an electric rotor.

As the circuit design and signal processing technology advances, there is a need to improve the magnetic sensor integrated circuit for the ease of use and accurate detection.

A motor can convert or transfer electrical energy based on the law of electromagnetic induction. A single phase permanent magnet motor is widely applied to various types of electrical appliance due to simple operation and convenient control. However, forward or reverse rotation of some motors is controlled by jumpers arranged on circuit boards of the motors; hence it is not convenient to operate.

### BRIEF DESCRIPTION OF THE DRAWINGS

FIG. 1 illustrates a prior art drive circuit for a synchronous motor, according to an embodiment of the present disclosure;

FIG. 2 illustrates a waveform of the drive circuit shown in FIG. 1;

FIG. 3 illustrates a diagrammatic representation of a synchronous motor, according to an embodiment of the present disclosure;

FIG. 4 illustrates a block diagram of a drive circuit for a synchronous motor, according to an embodiment of the present disclosure;

FIG. 5 illustrates a drive circuit for a synchronous motor, according to an embodiment of the present disclosure;

FIG. 6 illustrates a waveform of the drive circuit shown in FIG. 5;

FIGS. 7 to 10 illustrate different embodiments of a drive circuit of a synchronous motor, according to an embodiment of the present disclosure;

FIG. 11 shows a single phase permanent magnet synchronous motor according to an embodiment of the present disclosure;

FIG. 12 shows a circuit principle diagram of a single phase permanent magnet synchronous motor according to an embodiment of the present disclosure;

FIG. 13 and FIG. 14 show circuit block diagrams of an embodiment of the motor driving circuit shown in FIG. 12;

FIG. 15 shows a circuit diagram of a first embodiment of the motor driving circuit according to the present disclosure;

FIG. 16 shows a circuit diagram of a second embodiment of the motor driving circuit according to the present disclosure;

FIG. 17 and FIG. 18 show circuit diagrams of an embodiment of a switch control circuit in the motor driving circuit; and

FIG. 19 shows a circuit diagram of a third embodiment of the motor driving circuit according to the present disclosure.

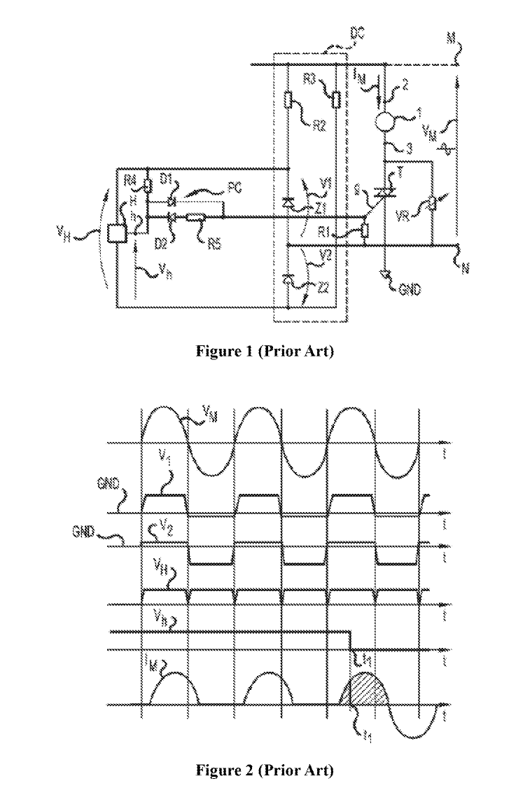

### DETAILED DESCRIPTION OF THE EMBODIMENTS

Hereinafter technical solutions in embodiments of the present disclosure are described clearly and completely in conjunction with the drawings in the embodiments of the present disclosure. Apparently, the described embodiments are only some rather than all of the embodiments of the present disclosure. Any other embodiments obtained based on the embodiments in the present disclosure by those skilled in the art without any creative work fall within the protection scope of the present disclosure. It should be understood that, the drawings only provide reference and illustration and are not intended to limit the present disclosure. Connections shown in the drawings are used to describe clearly, and are not intended to limit connection manners.

It should be noted that, when one component is “connected” to another component, the one component may be directly connected to the another component or the one component may be connected to the another component via a middle component. Unless otherwise defined, all technological and scientific terms used herein have the same meaning as that generally understood by those skilled in the art of the present disclosure. Terms used in the specification of the present disclosure herein are only used to describe specific embodiments, and are not intended to limit the present disclosure.

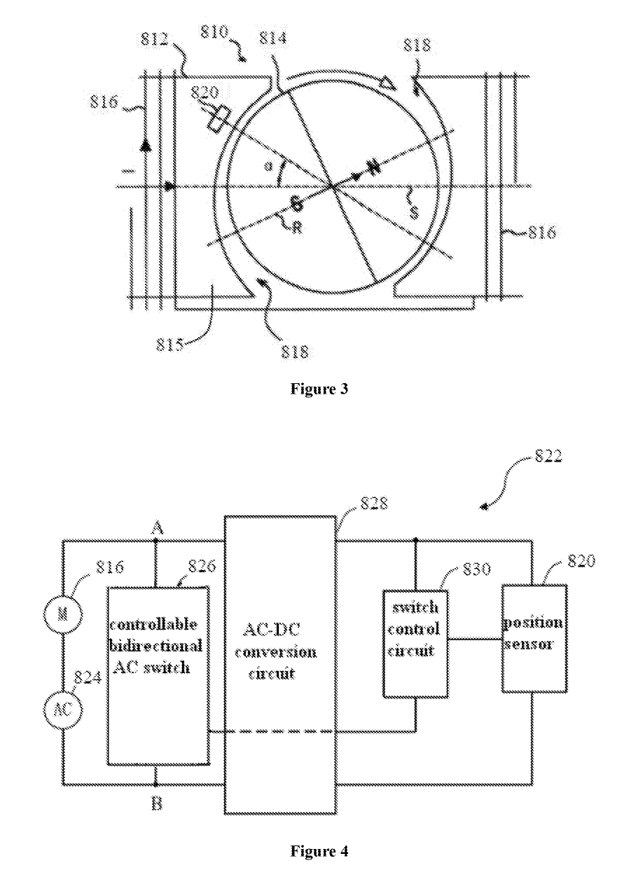

FIG. 3 schematically shows a synchronous motor according to an embodiment of the present invention. The synchronous motor 810 includes a stator 812 and a permanent magnet rotor 814 rotatably disposed between magnetic poles of the stator 812, and the stator 812 includes a stator core 815 and a stator winding 816 wound on the stator core 815. The rotor 814 includes at least one permanent magnet forming at least one pair of permanent magnetic poles with opposite polarities, and the rotor 814 operates at a constant rotational speed of 60 f/p rpm during a steady state phase in a case that the stator winding 816 is connected to an AC power supply, where f is a frequency of the AC power supply and p is the number of pole pairs of the rotor.

Non-uniform gap 818 is formed between the magnetic poles of the stator 812 and the permanent magnetic poles of the rotor 814 so that a polar axis R of the rotor 814 has an angular offset α relative to a central axis S of the stator 812 in a case that the rotor is at rest. The rotor 814 may be configured to have a fixed starting direction (a clockwise direction in this embodiment as shown by the arrow in FIG. 3) every time the stator winding 816 is energized. The stator and the rotor each have two magnetic poles as shown in FIG. 3. It can be understood that, in other embodiments, the stator and the rotor may also have more magnetic poles, such as 4 or 6 magnetic poles.

A position sensor 820 for detecting the angular position of the rotor is disposed on the stator 812 or at a position near the rotor inside the stator, and the position sensor 820 has an angular offset relative to the central axis S of the stator. Preferably, this angular offset is also α, as in this embodiment. Preferably, the position sensor 820 is a Hall effect sensor.

FIG. 4 shows a block diagram of a drive circuit for a synchronous motor according to an embodiment of the present invention. In the drive circuit 822, the stator winding 816 and the AC power supply 824 are connected in series between two nodes A and B. Preferably, the AC power supply 824 may be a commercial AC power supply with a fixed frequency, such as 50 Hz or 60 Hz, and a supply voltage may be, for example, 110V, 220V or 230V. A controllable bidirectional AC switch 826 is connected between the two nodes A and B, in parallel with the stator winding 816 and the AC power supply 824. Preferably, the controllable bidirectional AC switch 826 is a TRIAC, of which two anodes are connected to the two nodes A and B respectively. It can be understood that, the controllable bidirectional AC switch 826 alternatively may be two silicon control rectifiers reversely connected in parallel, and control circuits may be correspondingly configured to control the two silicon control rectifiers in a preset way. An AC-DC conversion circuit 828 is also connected between the two nodes A and B. An AC voltage between the two nodes A and B is converted by the AC-DC conversion circuit 828 into a low voltage DC. The position sensor 820 may be powered by the low voltage DC output by the AC-DC conversion circuit 828, for detecting the magnetic pole position of the permanent magnet rotor 814 of the synchronous motor 810 and outputting a corresponding signal. A switch control circuit 830 is connected to the AC-DC conversion circuit 828, the position sensor 820 and the controllable bidirectional AC switch 826, and is configured to control the controllable bidirectional AC switch 826 to be switched between a switch-on state and a switch-off state in a predetermined way, based on the magnetic pole position of the permanent magnet rotor which is detected by the position sensor and polarity information of the AC power supply 824 which may be obtained from the AC-DC conversion circuit 828, such that the stator winding 816 urges the rotor 814 to rotate only in the above-mentioned fixed starting direction during a starting phase of the motor. According to this embodiment of the present invention, in a case that the controllable bidirectional AC switch 826 is switched on, the two nodes A and B are shorted, the AC-DC conversion circuit 828 does not consume electric energy since there is no current flowing through the AC-DC conversion circuit 828, hence, the utilization efficiency of electric energy can be improved significantly.

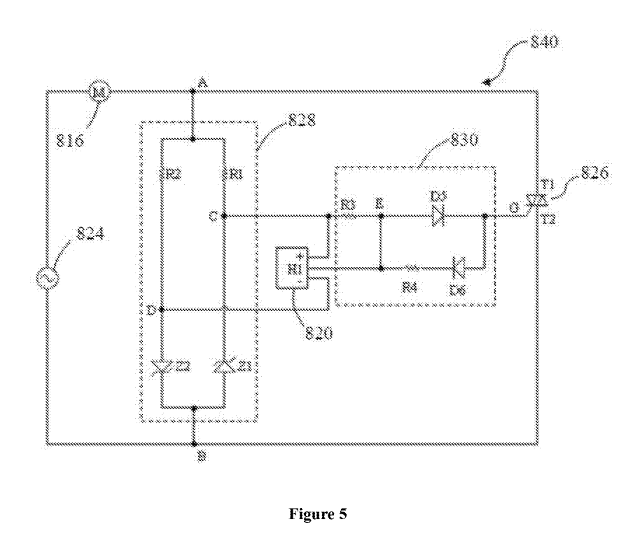

FIG. 5 shows a circuit diagram of a drive circuit 840 for a synchronous motor according to a first embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC (preferably, low voltage ranges from 3V to 18V). The AC-DC conversion circuit 828 includes a first zener diode Z1 and a second zener diode Z2 which are reversely connected in parallel between the two nodes A and B via a first resistor R1 and a second resistor R2 respectively. A high voltage output terminal C of the AC-DC conversion circuit 828 is formed at a connection point of the first resistor R1 and a cathode of the first zener diode Z1, and a low voltage output terminal D of the AC-DC conversion circuit 828 is formed at a connection point of the second resistor R2 and an anode of the second zener diode Z2. The voltage output terminal C is connected to a positive power supply terminal of the position sensor 820, and the voltage output terminal D is connected to a negative power supply terminal of the position sensor 820. Three terminals of the switch control circuit 830 are connected to the high voltage output terminal C of the AC-DC conversion circuit 828, an output terminal H1 of the position sensor 820 and a control electrode G of the TRIAC 826 respectively. The switch control circuit 830 includes a third resistor R3, a fifth diode D5, and a fourth resistor R4 and a sixth diode D6 connected in series between the output terminal H1 of the position sensor 820 and the control electrode G of the controllable bidirectional AC switch 826. An anode of the sixth diode D6 is connected to the control electrode G of the controllable bidirectional AC switch 826. One terminal of the third resistor R3 is connected to the high voltage output terminal C of the AC-DC conversion circuit 828, and the other terminal of the third resistor R3 is connected to an anode of the fifth diode D5. A cathode of the fifth diode D5 is connected to the control electrode G of the controllable bidirectional AC switch 826.

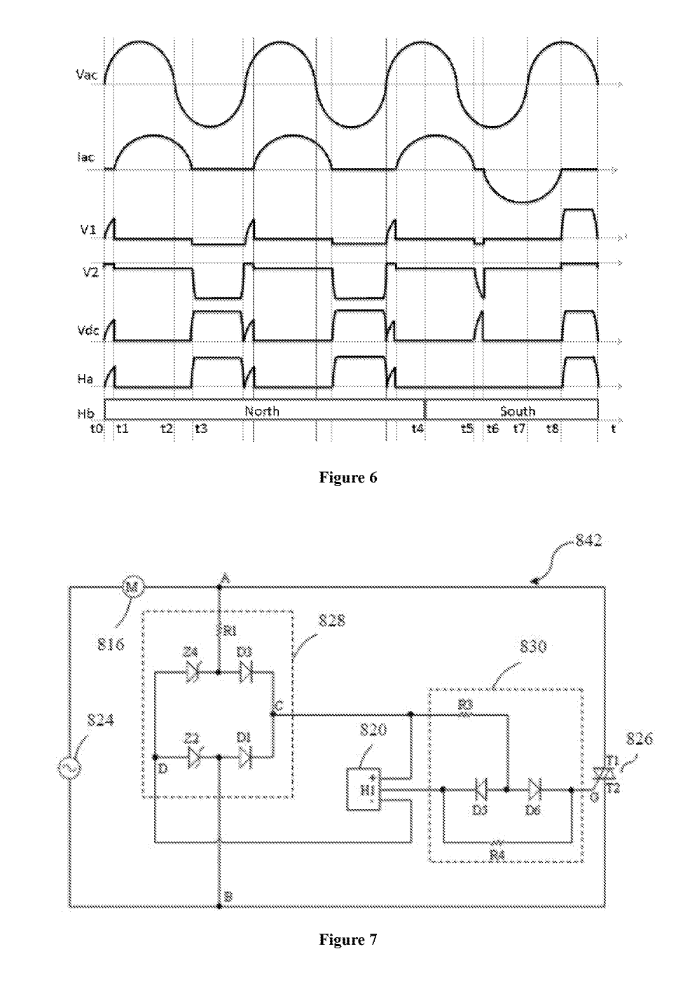

In conjunction with FIG. 6, an operational principle of the drive circuit 840 is described. In FIG. 6, Vac indicates a waveform of voltage of the AC power supply 824, and lac indicates a waveform of current flowing through the stator winding 816. Due to the inductive character of the stator winding 816, the waveform of current lac lags behind the waveform of voltage Vac. V1 indicates a waveform of voltage between two terminals of the first zener diode Z1, V2 indicates a waveform of voltage between two terminals of the second zener diode Z2, Vdc indicates a waveform of voltage between two output terminals C and D of the AC-DC conversion circuit 828, Ha indicates a waveform of a signal output by the output terminal H1 of the position sensor 820, and Hb indicates a rotor magnetic field detected by the position sensor 820. In this embodiment, in a case that the position sensor 820 is powered normally, the output terminal H1 outputs a logic high level in a case that the detected rotor magnetic field is North, or the output terminal H1 outputs a logic low level in a case that the detected rotor magnetic field is South.

In a case that the rotor magnetic field Hb detected by the position sensor 820 is North, in a first positive half cycle of the AC power supply, the supply voltage is gradually increased from a time instant t0 to a time instant t1, the output terminal H1 of the position sensor 820 outputs a high level, and a current flows through the resistor R1, the resistor R3, the diode D5 and the control electrode G and the second anode T2 of the TRIAC 826 sequentially. The TRIAC 826 is switched on in a case that a drive current flowing through the control electrode G and the second anode T2 is greater than a gate triggering current Ig. Once the TRIAC 826 is switched on, the two nodes A and B are shorted, a current flowing through the stator winding 816 in the motor is gradually increased until a large forward current flows through the stator winding 816 to drive the rotor 814 to rotate clockwise as shown in FIG. 3. Since the two nodes A and B are shorted, there is no current flowing through the AC-DC conversion circuit 28 from the time instant t1 to a time instant t2. Hence, the resistors R1 and R2 do not consume electric energy, and the output of the position sensor 820 is stopped due to no power is supplied. Since the current flowing through two anodes T1 and T2 of the TRIAC 826 is large enough (which is greater than a holding current Ihold), the TRIAC 826 is kept to be switched on in a case that there is no drive current flowing through the control electrode G and the second anode T2. In a negative half cycle of the AC power supply, after a time instant t3, a current flowing through T1 and T2 is less than the holding current Ihold, the TRIAC 826 is switched off, a current begins to flow through the AC-DC conversion circuit 828, and the output terminal H1 of the position sensor 820 outputs a high level again. Since a potential at the point C is lower than a potential at the point E, there is no drive current flowing through the control electrode G and the second anode T2 of the TRIAC 826, and the TRIAC 826 is kept to be switched off. Since the resistance of the resistors R1 and R2 in the AC-DC conversion circuit 828 are far greater than the resistance of the stator winding 816 in the motor, a current currently flowing through the stator winding 816 is far less than the current flowing through the stator winding 816 from the time instant t1 to the time instant t2 and generates very small driving force for the rotor 814. Hence, the rotor 814 continues to rotate clockwise due to inertia. In a second positive half cycle of the AC power supply, similar to the first positive half cycle, a current flows through the resistor R1, the resistor R3, the diode D5, and the control electrode G and the second anode T2 of the TRIAC 826 sequentially. The TRIAC 826 is switched on again, and the current flowing through the stator winding 816 continues to drive the rotor 814 to rotate clockwise. Similarly, the resistors R1 and R2 do not consume electric energy since the two nodes A and B are shorted. In the next negative half cycle of the power supply, the current flowing through the two anodes T1 and T2 of the TRIAC 826 is less than the holding current Ihold, the TRIAC 826 is switched off again, and the rotor continues to rotate clockwise due to the effect of inertia.

At a time instant t4, the rotor magnetic field Hb detected by the position sensor 820 changes to be South from North, the AC power supply is still in the positive half cycle and the TRIAC 826 is switched on, the two nodes A and B are shorted, and there is no current flowing through the AC-DC conversion circuit 828. After the AC power supply enters the negative half cycle, the current flowing through the two anodes T1 and T2 of the TRIAC 826 is gradually decreased, and the TRIAC 826 is switched off at a time instant t5. Then the current flows through the second anode T2 and the control electrode G of the TRIAC 826, the diode D6, the resistor R4, the position sensor 820, the resistor R2 and the stator winding 816 sequentially. As the drive current is gradually increased, the TRIAC 826 is switched on again at a time instant t6, the two nodes A and B are shorted again, the resistors R1 and R2 do not consume electric energy, and the output of the position sensor 820 is stopped due to no power is supplied. There is a larger reverse current flowing through the stator winding 816, and the rotor 814 continues to be driven clockwise since the rotor magnetic field is South. From the time instant t5 to the time instant t6, the first zener diode Z1 and the second zener diode Z2 are switched on, hence, there is a voltage output between the two output terminals C and D of the AC-DC conversion circuit 828. At a time instant t7, the AC power supply enters the positive half cycle again, the TRIAC 826 is switched off when the current flowing through the TRIAC 826 crosses zero, and then a voltage of the control circuit is gradually increased. As the voltage is gradually increased, a current begins to flow through the AC-DC conversion circuit 828, the output terminal H1 of the position sensor 820 outputs a low level, there is no drive current flowing through the control electrode G and the second anode T2 of the TRIAC 826, hence, the TRIAC 826 is switched off. Since the current flowing through the stator winding 816 is very small, nearly no driving force is generated for the rotor 814. At a time instant t8, the power supply is in the positive half cycle, the position sensor outputs a low level, the TRIAC 826 is kept to be switched off after the current crosses zero, and the rotor continues to rotate clockwise due to inertia. According to an embodiment of the present invention, the rotor may be accelerated to be synchronized with the stator after rotating only one circle after the stator winding is energized.

In the embodiment of the present invention, by taking advantage of a feature of a TRIAC that the TRIAC is kept to be switched on although there is no drive current flowing though the TRIAC once the TRIAC is switched on, it is avoided that a resistor in the AC-DC conversion circuit still consumes electric energy after the TRIAC is switched on, hence, the utilization efficiency of electric energy can be improved significantly.

FIG. 7 shows a circuit diagram of a drive circuit 842 for a synchronous motor according to an embodiment of the present disclosure. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes a first diode D1 and a third diode D3 reversely connected in series, and the other of the two rectifier branches includes a second zener diode Z2 and a fourth zener diode Z4 reversely connected in series, the high voltage output terminal C of the AC-DC conversion circuit 828 is formed at a connection point of a cathode of the first diode D1 and a cathode of the third diode D3, and the low voltage output terminal D of the AC-DC conversion circuit 828 is formed at a connection point of an anode of the second zener diode Z2 and an anode of the fourth zener diode Z4. The output terminal C is connected to a positive power supply terminal of the position sensor 820, and the output terminal D is connected to a negative power supply terminal of the position sensor 820. The switch control circuit 30 includes a third resistor R3, a fourth resistor R4, and a fifth diode D5 and a sixth diode D6 reversely connected in series between the output terminal H1 of the position sensor 820 and the control electrode G of the controllable bidirectional AC switch 826. A cathode of the fifth diode D5 is connected to the output terminal H1 of the position sensor, and a cathode of the sixth diode D6 is connected to the control electrode G of the controllable bidirectional AC switch. One terminal of the third resistor R3 is connected to the high voltage output terminal C of the AC-DC conversion circuit, and the other terminal of the third resistor R3 is connected to a connection point of an anode of the fifth diode D5 and an anode of the sixth diode D6. Two terminals of the fourth resistor R4 are connected to a cathode of the fifth diode D5 and a cathode of the sixth diode D6 respectively.

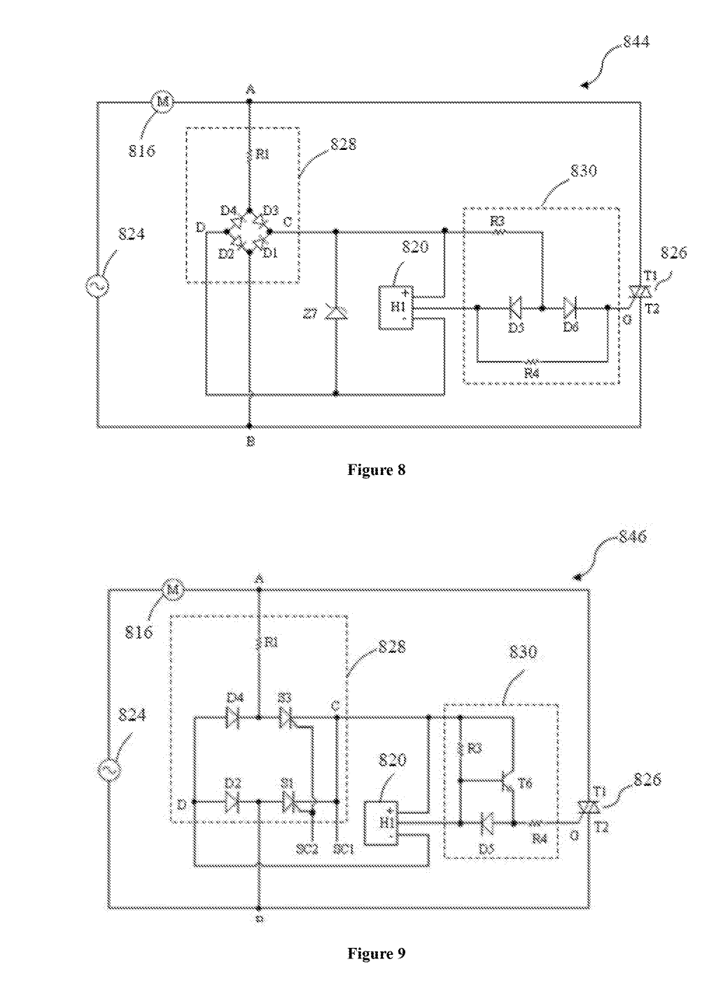

FIG. 8 shows a circuit diagram of a drive circuit 844 for a synchronous motor according to a further embodiment of the present invention. The drive circuit 844 is similar to the drive circuit 842 in the previous embodiment and, the drive circuit 844 differs from the drive circuit 842 in that, the zener diodes Z2 and Z4 in the drive circuit 842 are replaced by general diodes D2 and D4 in the rectifier of the drive circuit 844. In addition, a zener diode Z7 is connected between the two output terminals C and D of the AC-DC conversion circuit 828 in the drive circuit 844.

FIG. 9 shows a circuit diagram of a drive circuit 846 for a synchronous motor according to further embodiment of the present invention. The stator winding 816 of the synchronous motor is connected in series with the AC power supply 824 between the two nodes A and B. A first anode T1 of the TRIAC 826 is connected to the node A, and a second anode T2 of the TRIAC 826 is connected to the node B. The AC-DC conversion circuit 828 is connected in parallel with the TRIAC 826 between the two nodes A and B. An AC voltage between the two nodes A and B is converted by the AC-DC conversion circuit 828 into a low voltage DC, preferably, a low voltage ranging from 3V to 18V. The AC-DC conversion circuit 828 includes a first resistor R1 and a full wave bridge rectifier connected in series between the two nodes A and B. The full wave bridge rectifier includes two rectifier branches connected in parallel, one of the two rectifier branches includes two silicon control rectifiers S1 and S3 reversely connected in series, and the other of the two rectifier branches includes a second diode D2 and a fourth diode D4 reversely connected in series. The high voltage output terminal C of the AC-DC conversion circuit 828 is formed at a connection point of a cathode of the silicon control rectifier S1 and a cathode of the silicon control rectifier S3, and the low voltage output terminal D of the AC-DC conversion circuit 828 is formed at a connection point of an anode of the second diode D2 and an anode of the fourth diode D4. The output terminal C is connected to a positive power supply terminal of the position sensor 820, and the output terminal D is connected to a negative power supply terminal of the position sensor 820. The switch control circuit 830 includes a third resistor R3, an NPN transistor T6, and a fourth resistor R4 and a fifth diode D5 connected in series between the output terminal H1 of the position sensor 820 and the control electrode G of the controllable bidirectional AC switch 826. A cathode of the fifth diode D5 is connected to the output terminal H1 of the position sensor. One terminal of the third resistor R3 is connected to the high voltage output terminal C of the AC-DC conversion circuit, and the other terminal of the third resistor R3 is connected to the output terminal H1 of the position sensor. A base of the NPN transistor T6 is connected to the output terminal H1 of the position sensor, an emitter of the NPN transistor T6 is connected to an anode of the fifth diode D5, and a collector of the NPN transistor T6 is connected to the high voltage output terminal C of the AC-DC conversion circuit.

In this embodiment, a reference voltage may be input to the cathodes of the two silicon control rectifiers S1 and S3 via a terminal SC1, and a control signal may be input to control terminals of S1 and S3 via a terminal SC2. The rectifiers S1 and S3 are switched on in a case that the control signal input from the terminal SC2 is a high level, or are switched off in a case that the control signal input from the terminal SC2 is a low level. Based on the configuration, the rectifiers S1 and S3 may be switched between a switch-on state and a switch-off state in a preset way by inputting the high level from the terminal SC2 in a case that the drive circuit operates normally. The rectifiers S1 and S3 are switched off by changing the control signal input from the terminal SC2 from the high level to the low level in a case that the drive circuit fails. In this case, the TRIAC 826, the conversion circuit 828 and the position sensor 820 are switched off, to ensure the whole circuit to be in a zero-power state.

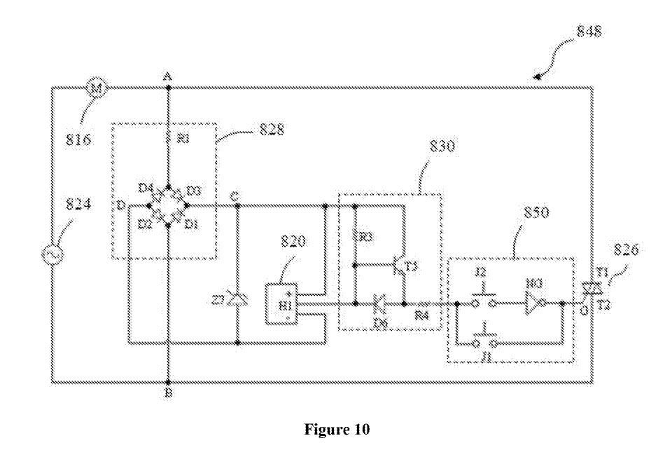

FIG. 10 shows a circuit diagram of a drive circuit 848 for a synchronous motor according to another embodiment of the present invention. The drive circuit 848 is similar to the drive circuit 846 in the previous embodiment and, the drive circuit 848 differs from the drive circuit 846 in that, the silicon control diodes S1 and S3 in the drive circuit 846 are replaced by general diodes D1 and D3 in the rectifier of the drive circuit 848, and a zener diode Z7 is connected between the two terminals C and D of the AC-DC conversion circuit 828. In addition, in the drive circuit 848 according to the embodiment, a preset steering circuit 850 is disposed between the switch control circuit 30 and the TRIAC 826. The preset steering circuit 850 includes a first jumper switch J1, a second jumper J2 switch and an inverter NG connected in series with the second jumper switch J2. Similar to the drive circuit 846, in this embodiment, the switch control circuit 830 includes the resistor R3, the resistor R4, the NPN transistor T5 and the diode D6. One terminal of the resistor R4 is connected to a connection point of an emitter of the transistor T5 and an anode of the diode D6, and the other terminal of the resistor R4 is connected to one terminal of the first jumper switch J1, and the other terminal of the first jumper switch J1 is connected to the control electrode G of the TRIAC 826, and the second jumper switch J2 and the inverter NG connected in series are connected across two terminals of the first jumper switch J1. In this embodiment, when the first jumper switch J1 is switched on and the second jumper switch J2 is switched off, similar to the above embodiments, the rotor 814 still starts clockwise; when the second jumper switch J2 is switched on and the first jumper switch J1 is switched off, the rotor 814 starts counterclockwise. In this case, a starting direction of the rotor in the motor may be selected by selecting one of the two jumper switches to be switched on and the other to be switched off. Therefore, in a case that a driving motor is needed to be supplied for different applications having opposite rotational directions, it is just needed to select one of the two jumper switches J1 and J2 to be switched on and the other to be switched off, and no other changes need to be made to the drive circuit, hence, the drive circuit according to this embodiment has good versatility.

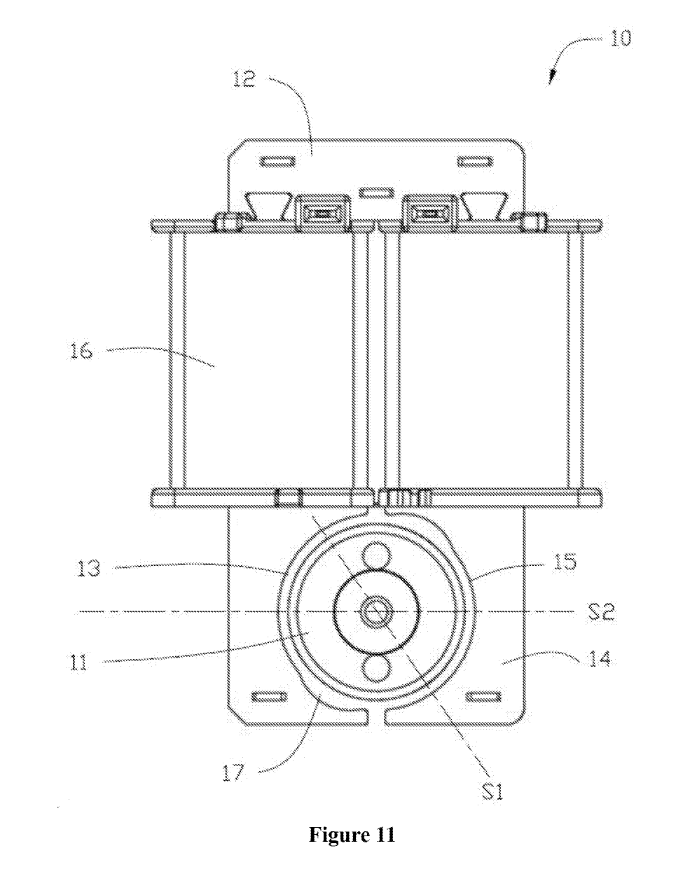

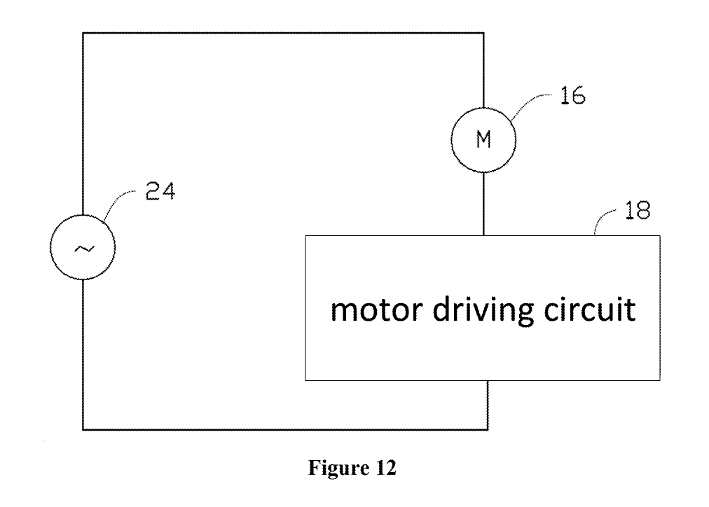

FIG. 11 shows a single phase permanent magnet motor according to an embodiment of the present disclosure. A motor 10 can include a stator and a rotor 11 rotatable relative to the stator. The stator can include a stator core 12 and a stator winding 16 wound on the stator core 12. The stator core may be made of soft magnetic materials such as pure iron, cast iron, cast steel, electrical steel, silicon steel and ferrite. The rotor 11 is a permanent magnet rotor. The rotor 11 operates at a constant rotational speed of 60 f/p rpm during a steady state phase when the stator winding 16 is connected in series to an alternate current power supply 24 (as shown in FIG. 12), where f denotes a frequency of the AC power supply and p denotes the number of pole pairs of the rotor. In the embodiment, the stator core 12 includes a pair of opposing pole portions 14. Each of the pair of opposing poles 14 includes a pole arc surface 15. An outside surface of the rotor 11 is opposite to the pole arc surface 15 with a substantially even air gap 13 formed between the outside surface of the rotor 11 and the pole arc 15. The “substantially even air gap” in the present disclosure means that an even air gap is formed in most space between the stator and the rotor, and an uneven air gap is formed in a small part of the space between the stator and the rotor. Preferably, a starting groove 17 which is concave may be disposed in the pole arc surface 15 of the pole of the stator, and a part of the pole arc surface 15 other than the starting groove 17 may be concentric with the rotor. With the configuration described above, a non-uniform magnetic field may be formed, to ensure that a polar axis S1 of the rotor has an inclination angle relative to a central axis S2 of the pair of opposing pole portions 14 of the stator when the rotor is static. Such configuration allows the rotor 11 to have a starting torque under the action of a motor driving circuit 18 each time the motor is powered on. In the embodiment, the “pole axis S1 of the rotor” can be a separation boundary between two magnetic poles having different polarities, and the “central axis S2 of the pole 14 of the stator” can be a connection line passing through the opposing pole portions in the center. In the embodiment, each of the stator and the rotor can include two magnetic poles. It can be understood that the number of magnetic poles of the stator may not be equal to the number of magnetic poles of the rotor, and the stator and the rotor may have more magnetic poles, such as 4 or 6 magnetic poles in other embodiments.

FIG. 12 shows a circuit principle diagram of a single phase permanent magnet synchronous motor 10 according to another embodiment of the present disclosure. The stator winding 16 of the motor 10 is connected in series to a motor driving circuit 18 between two terminals of the alternate current power supply 24. The motor driving circuit 18 controls forward and reverse rotation of the motor. The alternate current power supply 24 may be 110V, 220V, 230V or an alternate current outputted by an inverter.

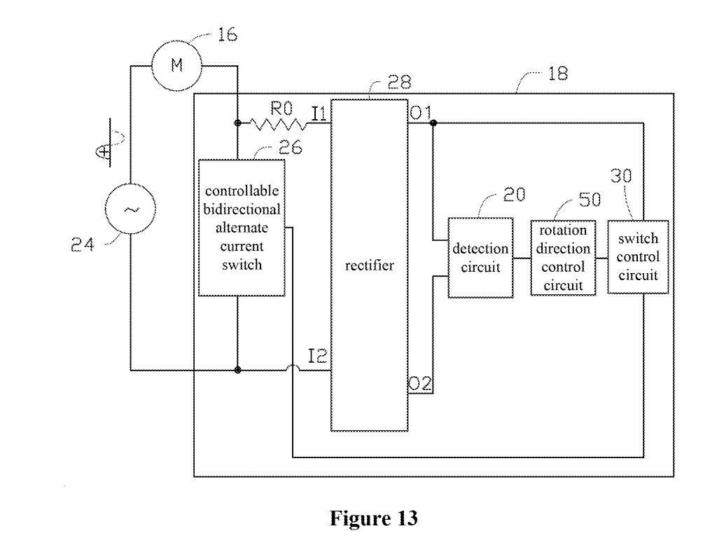

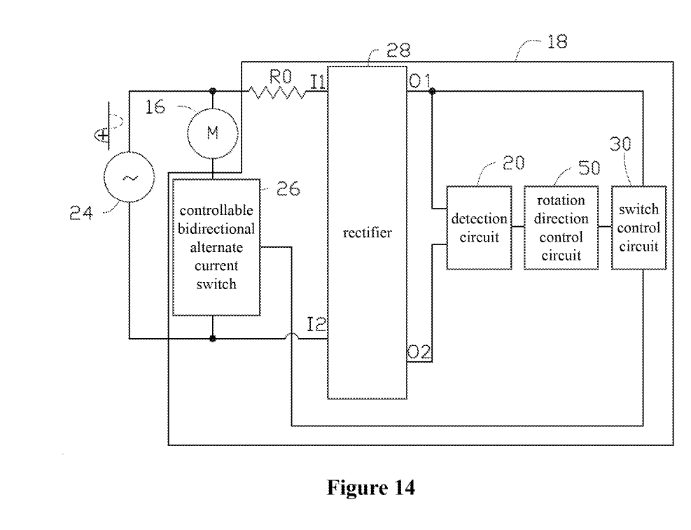

FIG. 13 shows a block diagram of an embodiment of the motor driving circuit 18. The motor driving circuit 18 includes a detection circuit 20, a rectifier 28, a controllable bidirectional alternate current switch 26, a switch control circuit 30 and a rotation direction control circuit 50. The stator winding 16 of the motor is connected in series to the controllable bidirectional alternate current switch 26 between two terminals of the alternate current power supply 24. A first input terminal I1 of the rectifier 28 is connected to a node between the stator winding 16 and the controllable bidirectional alternate current switch 26 via a resistor R0. A second input terminal 12 of the rectifier 28 is connected to a connection node between the controllable bidirectional alternate current switch 26 and the alternate current power supply 24, so as to convert the an alternate current into a direct current and provide the direct current to the detection circuit 20. The detection circuit 20 detects a magnetic pole position of the rotor 11, and outputs a respective magnetic pole position signal via an output terminal of the detection circuit 20, for example 5V or 0V. The rotation direction control circuit 50 is connected to the detection circuit 20 and configured to selectively output, based on rotation direction set of the motor, a magnetic pole position signal outputted by the detection circuit 20 or a signal obtained by inverting the magnetic pole position signal to the switch control circuit 30. The switch control circuit 30 controls, based on the received signal and polarity information of the alternate current power supply, the controllable bidirectional alternate current switch 26 to be turned on and turned off alternately, to determine forward rotation or reverse rotation of the motor. Referring to FIG. 14, in another embodiments, the first input terminal I1 of the rectifier 28 is connected to a node between the stator winding 16 and the alternate current power supply 24 via the resistor R0, and the second input terminal 12 of the rectifier 28 is connected to a node between the alternate current power supply 24 and the controllable bidirectional alternate current switch 26.

The detection circuit 20 is configured to detect a magnetic pole position of the rotor 11 of the motor. The detection circuit 20 is preferably a hall sensor 22. In the embodiment, the hall sensor 22 is arranged adjacent to the rotor 11 of the motor.

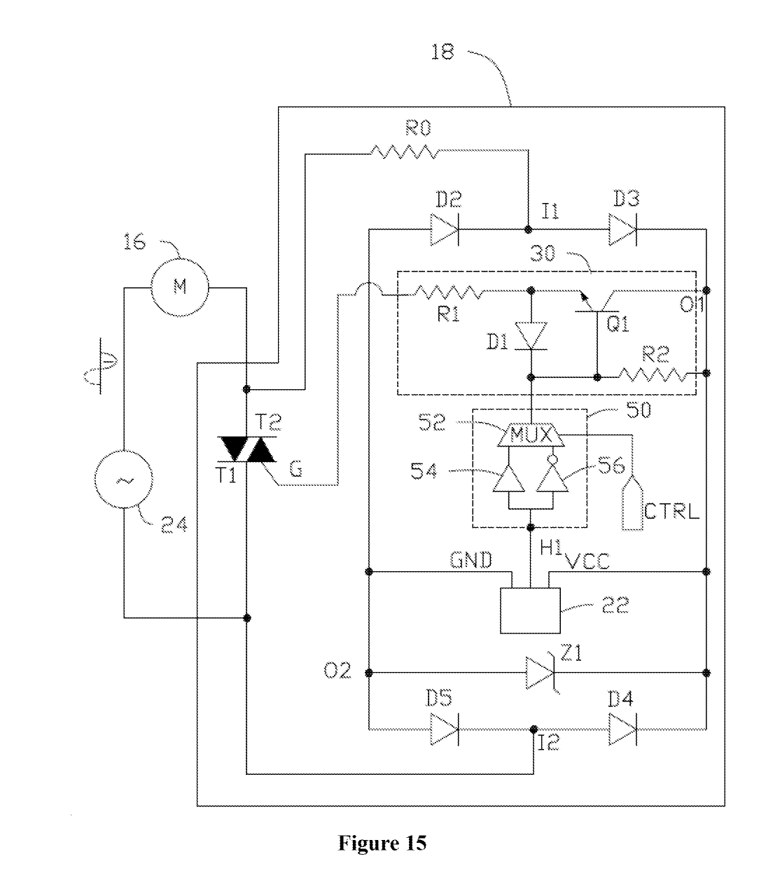

Reference is made to FIG. 15 which shows a specific circuit diagram of a first embodiment of the motor driving circuit 18 shown in FIG. 13.

The rectifier 28 includes four diodes D2 to D5. A cathode of the diode D2 is connected to an anode of the diode D3, a cathode of the diode D3 is connected to a cathode of the diode D4, an anode of the diode D4 is connected to a cathode of the diode D5, and an anode of the diode D5 is connected to an anode of the diode D2. The cathode of the diode D2 can be the first input terminal I1 of the rectifier 28 and electrically connected to the stator winding 16 of the motor 10 via a resistor R0. The resistor R0 may function as a voltage dropping unit. The anode of the diode D4 can be the second input terminal 12 of the rectifier 28 and electrically connected to the alternate current power supply 24. The cathode of the diode D3 can be a first output terminal O1 of the rectifier 28 and electrically connected to the hall sensor 22 and the switch control circuit 30. The first output terminal O1 outputs a high direct current operating voltage VDD. The anode of the diode D5 can be a second output terminal O2 of the rectifier 28 and electrically connected to the hall sensor 22. The second output terminal O2 outputs a voltage lower than the voltage outputted by the first output terminal. A zener diode Z1 is connected between the first output terminal O1 and the second output terminal O2 of the rectifier 28. An anode of the zener diode Z1 is connected to the second output terminal O2, and a cathode of the zener diode Z1 is connected to the first output terminal O1.

In the embodiment, the hall sensor 22 includes a power supply terminal VCC, a ground terminal GND and an output terminal H1. The power supply terminal VCC is connected to the first output terminal O1 of the rectifier 28, the ground terminal GND is connected to the second output terminal O2 of the rectifier 28, and the output terminal H1 is connected to the rotation direction control circuit 50. When the hall sensor 22 is powered on, i.e., the power supply VCC receives a high voltage and the ground terminal GND receives a low voltage, the output terminal H1 of the hall sensor 22 outputs a logic high level magnetic pole position signal when a detected rotor magnetic field indicates North, or the output terminal H1 of the hall sensor 22 outputs a logic low level magnetic pole position signal when the detected rotor magnetic field indicates South. In other embodiments, the output terminal H1 of the hall sensor 22 may output a logic low level magnetic pole position signal when the detected rotor magnetic field indicates North, or the output terminal H1 of the hall sensor 22 may output a logic high level magnetic pole position signal when the detected rotor magnetic field indicates South.

The rotation direction control circuit 50 includes a multiplexer (MUX) 52, a buffer 54 and an inverter 56. The MUX 52 includes two data input terminals, one data output terminal and one selection terminal. An input terminal of the buffer 54 is connected to an input terminal of the inverter 56, and a node between the input terminal of the buffer 54 and the input terminal of the inverter 56 can be an input terminal of the rotation direction control circuit 50. The output terminal H1 of the hall sensor 22 is connected to the input terminal of the rotation direction control circuit 50. An output terminal of the buffer 54 is connected to one data input terminal of the MUX 52, an output terminal of the inverter 56 is connected to the other data input terminal of the MUX 52. An output terminal of the MUX 52 can be the output terminal of the rotation direction control circuit 50 and electrically connected to the switch control circuit 30. The selection terminal of the MUX 52 receives a rotation direction set signal CTRL for controlling forward rotation or reverse rotation of the motor. The selection terminal of the MUX 52 selectively transmits, based on the rotation direction set signal CTRL, the magnetic pole position signal outputted by the hall sensor 22 or a signal obtained by inverting the magnetic pole position signal outputted by the hall sensor 22 to the switch control circuit 30. In other embodiments, buffer 54 may be omitted in the rotation direction control circuit 50, and the output terminal H1 of the hall sensor 22 is directly connected to one data input terminal of the MUX 52.

The switch control circuit 30 includes a first terminal, a second terminal, and a third terminal. The first terminal is connected to the first output terminal of the rectifier 28, the second terminal is connected to the output terminal of the rotation direction control circuit 50, and the third terminal is connected to a control electrode of the controllable bidirectional alternate current switch 26. The switch control circuit 30 includes a resistor R2, an NPN triode Q1 and a diode D1. A cathode of the diode D1 can be the second terminal to connect to the output terminal of the rotation direction control circuit 50. One end of the resistor R2 is connected to the first output terminal O1 of the rectifier 28, and the other end of the resistor R2 is connected to the output terminal of the rotation direction control circuit 50. A base electrode of the NPN triode Q1 is connected to the output terminal of the rotation direction control circuit 50, an emitting electrode of the NPN triode Q1 is connected to an anode of the diode D1, and a collecting electrode of the NPN triode Q1 servers as the first terminal and is connected to the first output terminal O1 of the rectifier 28. In the embodiment, the switch control circuit 30 further includes a current limiting resistor R1 connected between a control electrode G of the controllable bidirectional alternate current switch and an anode of the diode D1. One end of the current limiting resistor R1 not connected to the diode D1 servers as the third terminal.

The controllable bidirectional alternate current switch 26 can be a TRIAC. Two anodes T1 and T2 of the TRIAC are connected to the alternate current power supply 24 and the stator winding 16 respectively, and a control electrode G of the TRIAC is connected to the third terminal of the switch control circuit 30. It should be understood that, the controllable bidirectional alternate current switch 26 may include an electronic switch enabling bidirectional flow of a current, which may be composed of one or more of: a metal oxide semiconductor field-effect transistor, a silicon controlled rectifier, a TRIAC, an insulated gate bipolar transistor, a bipolar junction transistor, a semiconductor thyratron and an optocoupler. For example, two metal oxide semiconductor field-effect transistors may form a controllable bidirectional alternate current switch; two silicon controlled rectifiers may form a controllable bidirectional alternate current switch; two insulated gate bipolar transistors may form a controllable bidirectional alternate current switch; and two bipolar junction transistors may form a controllable bidirectional alternate current switch.

The switch control circuit 30 is configured to turn on the controllable bidirectional alternate current switch 26, when the alternate current power supply is in a positive half-period and the second terminal of the switch control circuit 30 receives a first level signal, or the alternate current power supply is in a negative half-period and the second terminal of the switch control circuit 30 receives a second level signal; and turn off the controllable bidirectional alternate current switch 26, when the alternate current power supply is in a negative half-period and the second terminal of the switch control circuit 30 receives the first level signal, or the alternate current power supply is in a positive half-period and the second terminal of the switch control circuit 30 receives the second level signal. Preferably, the first level signal is a logic high level signal, and the second level signal is a logic low level signal.

An operation principle of the motor driving circuit 18 is described in reference with FIG. 13 and FIG. 15 now.

It can be known according to the electromagnetic theory that, for a single phase permanent magnet motor, a rotation direction of the rotor of the motor may be changed by changing the direction of the current of the stator winding 16. Referring to FIG. 13 and FIG. 14, when polarity of the rotor sensed by the hall sensor 22 indicates an N pole, the alternate current in a positive half-period flows through the stator winding 16 (see FIG. 13), and the motor rotates reversely, for example rotating in a counterclockwise (CCW) manner. It should be understood that, if the polarity of the rotor sensed by the hall sensor 22 indicates an N pole, the alternate current in a negative half-period flows through the stator winding 16 (see FIG. 14), and the motor rotates forwardly, for example rotating in a clockwise (CW) manner. The present disclosure are designed based on the principle, i.e., the direction of the current flowing through the stator winding 16 is adjusted based on the polarity of the rotor sensed by the hall sensor 22, thereby controlling forward rotation and reverse rotation of the motor.

The following table 1 shows a functional table illustrating controlling forward and reverse rotation of the motor based on a rotation direction set signal CTRL.

TABLE 1

| rotation direction | output of | rotation direction |
|---|---|---|
| set signal | the MUX | of the motor |
| 0 | Hall | CCW |
| 1 | H̅a̅l̅l̅ | CW |

Now it is illustrated by assuming that the motor rotates forwardly. It is assumed that the rotation direction set signal CTRL outputs a logic high level “1”. When the motor starts and if a magnetic pole position of the rotor sensed by the hall sensor 22 indicates the N pole, the hall sensor 22 outputs a logic high level “1” magnetic pole position signal, the MUX 52 selects to output a logic low level “0” via inverting the magnetic pole position signal by the inverter 56, to the switch control circuit 30. The cathode of the diode D1 of the switch control circuit 30 receives the logic low level, and the triode Q1 is turned off. If the alternate current power supply is in a negative half-period when the motor starts, the alternate current in the negative half-period flows through the control electrode G of the controllable bidirectional alternate current switch 26, the resistor R1, the diode D1 and is grounded, the controllable bidirectional alternate current switch 26 is turned on, and the rotor 11 starts to rotate in the CW manner. If the alternate current power supply is in a positive half-period when the motor starts, the alternate current in the positive half-period can not pass the NPN triode Q1, no current flows through the control electrode G of the controllable bidirectional alternate current switch 26, the controllable bidirectional alternate current switch 26 is turned off, and the rotor 11 does not rotate.

If a rotor magnetic pole detected by the hall sensor 22 is an S pole, a logic low level “0” magnetic pole position signal is outputted. The MUX 52 selects to output a logic high level “1” obtained by inverting the magnetic pole position signal with the inverter 56, to the switch control circuit 30. The cathode of the diode D1 of the switch control circuit 30 receives the logic high level, the triode Q1 is turned on, hence the anode of the diode D1 is at a high level. If the alternate current power supply is in a negative half-period when the motor starts, the alternate current in the negative half-period cannot flow through the control electrode G of the controllable bidirectional alternate current switch 26 and the resistor R1, hence the controllable bidirectional alternate current switch 26 is turned off, and the rotor 11 does not rotate. If the alternate current power supply is in a positive half-period when the motor starts, the alternate current in the positive half-period flows to the control electrode G of the controllable bidirectional alternate current switch 26 through the NPN triode Q1 and the resistor R1, the controllable bidirectional alternate current switch 26 is turned on, the alternate current in the positive half-period flows through the stator winding, and the rotor 11 rotates in a CW manner.

If the motor is pre-controlled to rotate reversely, i.e., rotating in a CCW manner, the rotation direction set signal CTRL can be a logic low level “0”. If a magnetic pole position of the rotor sensed by the hall sensor 22 indicates an N pole, the output terminal H1 of the hall sensor 22 outputs a logic high level “1” magnetic pole position signal. The MUX 52 outputs the logic high level outputted by the hall sensor 22 to the cathode of the diode D1 via the buffer 54, the triode Q1 is turned on, hence the anode of the diode D1 is at a high level. If the alternate current power supply is in a negative half-period when the motor starts, the alternate current in the negative half-period cannot flow through the control electrode G of the controllable bidirectional alternate current switch 26 and the resistor R1, hence the controllable bidirectional alternate current switch 26 is turned off, and the rotor 11 does not rotate. If the alternate current power supply is in a positive half-period when the motor starts, the alternate current in the positive half-period flows to the control electrode G of the controllable bidirectional alternate current switch 26 through the triode Q1 and the resistor R1, the controllable bidirectional alternate current switch 26 is turned on, and the rotor 11 of the motor starts to rotate in a CCW manner.

If the magnetic pole position of the rotor sensed by the hall sensor 22 indicates an S pole, the output terminal H1 of the hall sensor 22 outputs a logic low level “0” magnetic pole position signal, the MUX 52 outputs the logic low level outputted by the hall sensor 22 to the cathode of the diode D1 via the buffer 54, and the triode Q1 is turned off. If the alternate current power supply is in a negative half-period when the motor starts, a current in the negative half-period flows through the control electrode G of the controllable bidirectional alternate current switch 26, the resistor R1, the diode D1 and is grounded, the controllable bidirectional alternate current switch 26 is turned on, the alternate current in the negative half-period flows through the stator winding, and the rotor 11 starts to rotate in a CCW manner. If the alternate current power supply is in a positive half-period when the motor starts, the alternate current in the positive half-period cannot pass the NPN triode Q1, no current flows through the control electrode G of the controllable bidirectional alternate current switch 26, the controllable bidirectional alternate current switch 26 is turned off, and the rotor 11 does not rotate.

The above case that the rotor 11 does not rotate refers to a case that when the motor is started. After the motor is started successfully, the rotor 11 maintains rotating due to inertia even if the controllable bidirectional alternate current switch 26 is turned off. In addition, in changing the rotation direction of the rotor 11, it is needed to stop rotation of the rotor 11 of the motor firstly. The rotation of the rotor 11 of the motor can be stopped easily. For example, a switch (not shown) may be provided between the alternate current power supply 24 and the stator winding 16 of the motor, and the rotation of the rotor may be stopped once the switch is turned off for a predetermined time.

The following table 2 shows a case that forward and reverse rotation of the motor is controlled based on the rotation direction set of the motor, the magnetic pole position of the rotor and the polarity of the power supply.

TABLE 2

| | | | | | output | |
|---|---|---|---|---|---|---|
| | output | rotation | | | terminal | |
| magnetic | terminal | direction | | | of | rotation |
| pole | H1 of | control circuit | | | switch | direction |
| position of | the hall | control | output | alternate | control | of the |
| the rotor | sensor | signal | terminal | current | circuit | motor |
| N | 1 | 0 | 1 | positive | 1 | CCW |
| | | | | half-period | | |
| S | 0 | | 0 | negative | 0 | CCW |
| | | | | half-period | | |
| N | 1 | | 1 | negative | 1 | maintain |
| | | | | half-period | | rotating due |
| | | | | | | to inertia |
| S | 0 | | 0 | positive | 0 | maintain |
| | | | | half-period | | rotating due |
| | | | | | | to inertia |
| N | 1 | 1 | 0 | negative | 0 | CW |
| | | | | half-period | | |
| S | 0 | | 1 | positive | 1 | CW |
| | | | | half-period | | |
| N | 1 | | 0 | positive | 0 | maintain |
| | | | | half-period | | rotating due |
| | | | | | | to inertia |
| S | 0 | | 1 | negative | 1 | maintain |
| | | | | half-period | | rotating due |
| | | | | | | to inertia |

In summary, the rotation direction control circuit 50 controls, based on rotation direction set of the motor, whether a signal received by the second terminal of the switch control circuit 30 is the magnetic pole position signal outputted by the hall sensor 22 or the signal obtained by inverting the magnetic pole position signal outputted by the hall sensor 22.

That is, the rotation direction control circuit 50 controls the level received by the second terminal of the switch control circuit 30, thereby controlling a switch state of the controllable bidirectional alternate current switch 26 based on polarity of the power supply to control the direct of the current flowing through the stator winding 16, and the rotation direction of the motor is controlled.

In other embodiments, the MUX 52 may be replaced with other types of selector switches. The selector switches may be mechanical switches or electronic switches. The mechanical switches can include a relay, a single-pole double-throw switch and a single-pole single-throw switch. The electronic switches include a solid-state relay, a metal oxide semiconductor field-effect transistor, a silicon controlled rectifier, a TRIAC, an insulated gate bipolar transistor, a bipolar junction transistor, a semiconductor thyratron and an optocoupler and so on.

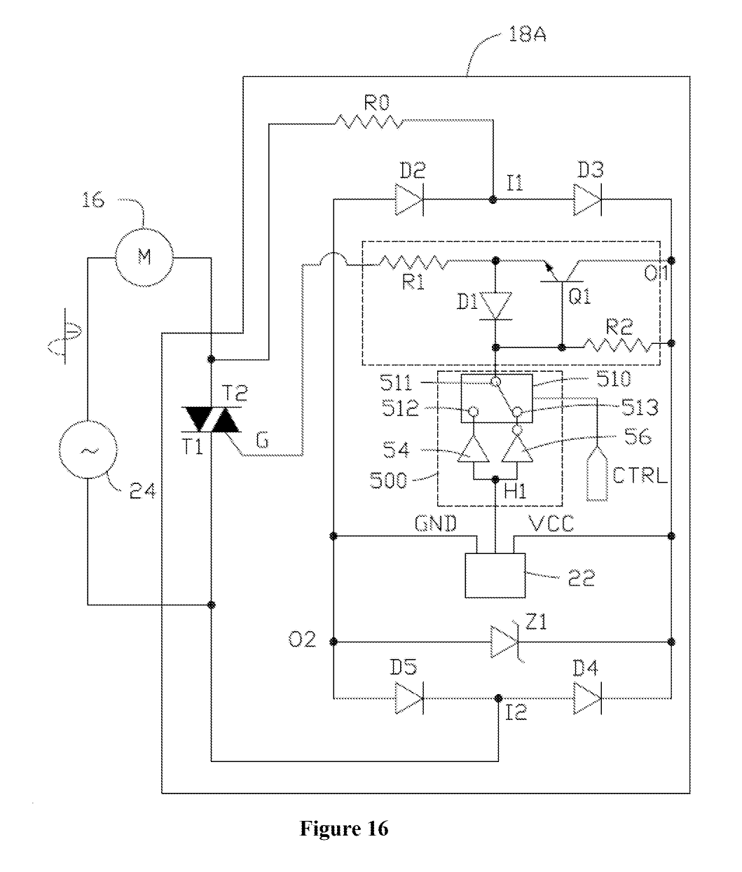

With Reference to FIG. 16, FIG. 16 shows a circuit diagram of a motor driving circuit 18A according to a second embodiment of the present disclosure. The driving circuit 18A is similar to the driving circuit 18 in the first embodiment shown in FIG. 15 driving circuit driving circuit except that the MUX 52 is replaced with a relay 510 in the rotation direction control circuit 500. The relay 510 includes a first terminal 511, a second terminal 512, a third terminal 513 and a control terminal. The control terminal receives the rotation direction set signal CTRL. An input terminal of the buffer 54 is connected to an input terminal of the inverter 56, and both of the input terminal of the buffer 54 and the input terminal of the inverter 56 are connected to the output terminal H1 of the hall sensor 22. The first terminal 511 is connected to a cathode of a diode D1, the second terminal 512 is connected to an output terminal of the buffer 54, and the third terminal 513 is connected to an output terminal of the inverter 56.

A principle for controlling forward and reverse rotation of the motor by the relay 510 is same as that in the first embodiment shown in FIG. 15. Specifically, when the motor is controlled to rotate forwardly, the rotation direction set signal CTRL can be a logic high level, the first terminal 511 of the relay 510 is connected to the third terminal 513 of the relay 510, the rotation direction control circuit 500 inverts a magnetic pole position signal outputted by the hall sensor 22 and outputs the inverted signal to the switch control circuit 30. And the switch control circuit 30 controls a conduction manner for the controllable bidirectional alternate current switch 26 to make the motor to rotate in a CW manner. When the motor is controlled to rotate reversely, the rotation direction set signal CTRL can be a logic low level, the first terminal 511 of the relay 510 is connected to the second terminal 512 of the relay 510, the rotation direction control circuit 500 outputs the magnetic pole position signal outputted by the hall sensor 22 to the switch control circuit 30, and the switch control circuit 30 controls the conduction manner for the controllable bidirectional alternate current switch 26 to make the motor to rotate in a CCW manner.

With the motor driving circuit according to the present disclosure, the rotation direction control circuit 50 controls the signal received by the switch control circuit 30 according to the magnetic pole position of the rotor 11, and further controls forward rotation or reverse rotation of the motor in conjunction with polarity of the alternate current power supply. If the magnetic pole position of the rotor 11 indicates an N pole and the switch control circuit 30 receives the magnetic pole position signal when the hall sensor is normally energized, i.e., a logic high level signal, the alternate current in the positive half-period is controlled to flow through the stator winding, and the motor rotates in a CCW manner. If the motor is controlled to rotate reversely and the magnetic pole position of the rotor 11 indicates an N pole, the rotation direction control circuit 50 inverts the magnetic pole position signal outputted by the hall sensor 22 and outputs the inverted signal to the switch control circuit 30, the switch control circuit 30 controls the alternate current in the negative half-period to flow through the stator winding 16, and in this way the rotor 11 rotates in a CW manner. The rotation direction control circuit 50 selectively transmits, based on the rotation direction set signal CTRL, the magnetic pole position signal outputted by the hall sensor 22 or the inverted signal obtained by inverting the magnetic pole position signal to the switch control circuit 30, to control a rotation direction of the motor. When it is needed to provide drive motors to different applications for opposite rotation directions, only the logic level of the rotation direction set signal CTRL is changed and no other change needs to be made for the driving circuit. Therefore, the motor driving circuit has a simple structure and strong versatility.

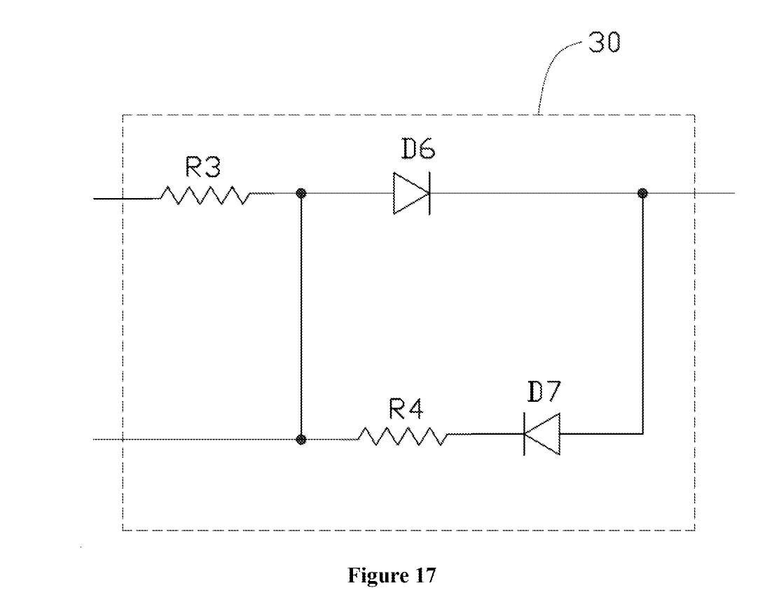

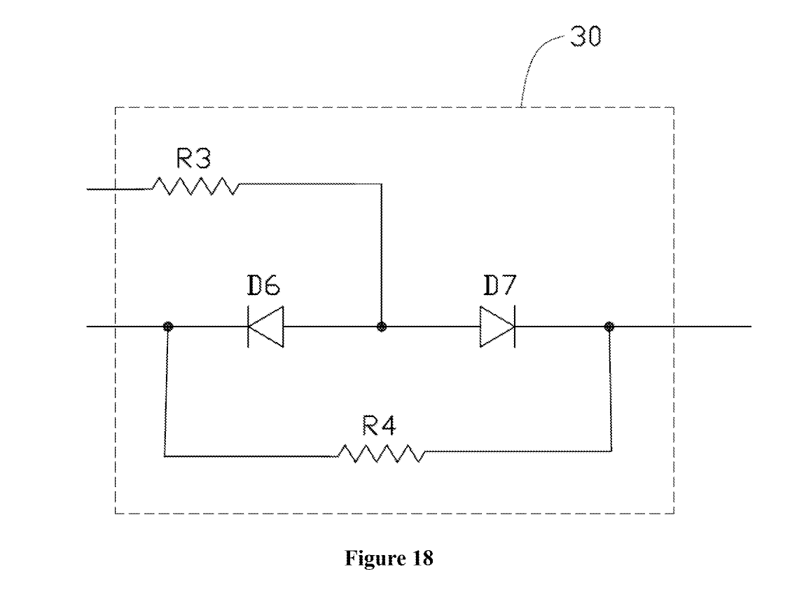

The switch control circuit having the current limiting resistor R1 shown in FIG. 15 and FIG. 16 according to the present disclosure is not limited to the circuit shown in FIG. 15, and the switch control circuit may be replaced with circuits shown in FIG. 17 and FIG. 18.

Specifically, referring to FIG. 17, a switch control circuit 30 includes a resistor R3, a diode D6, and a resistor R4 and a diode D7 connected in series to each other between the output terminal of the rotation direction control circuit 50 and the control electrode G of the controllable bidirectional alternate current switch 26. A cathode of the diode D7 is connected to the resistor R4, and an anode of the diode D7 is connected to the control electrode G of the controllable bidirectional alternate current switch. One end of the resistor R3 is connected to the first output terminal O1 of the rectifier 28, and the other end of the resistor R3 is connected to an anode of the diode D6. A cathode of the diode D6 is connected to the control electrode G of the controllable bidirectional alternate current switch 26.

Referring to FIG. 18, a switch control circuit 30 includes a resistor R3, a resistor R4, and a diode D6 and a diode D7 connected in series reversely to each other between the output terminal of the rotation direction control circuit 50 and the control electrode G of the controllable bidirectional alternate current switch 26. Cathodes of the diode D6 and the diode D7 are connected to the output terminal of the rotation direction control circuit 50 and the control electrode G of the controllable bidirectional alternate current switch respectively. One terminal of the resistor R3 is connected to the first output terminal O1 of the rectifier 28, and the other terminal of the resistor R3 is connected to a connection point of anodes of the diode D6 and the diode D7. Two ends of the resistor R4 are connected to cathodes of the diode D6 and the diode D7 respectively.

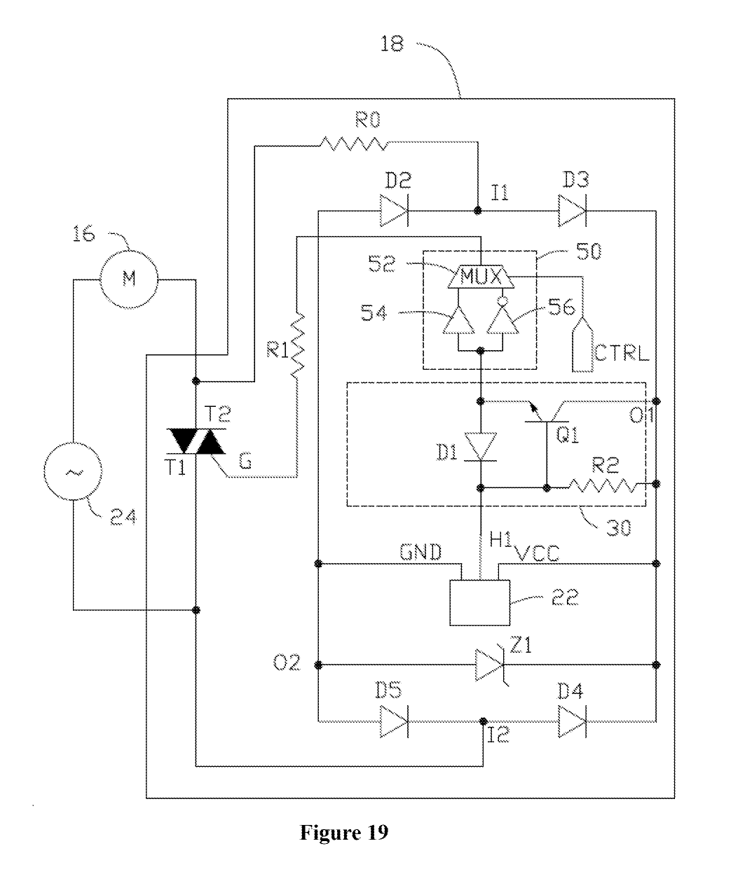

With Reference to FIG. 19, FIG. 19 shows a circuit diagram of a third embodiment of the motor driving circuit according to the present disclosure. A circuit structure in the embodiment shown in FIG. 19 is substantially the same as the circuit structure in the embodiment shown in FIG. 15 except that: in the embodiment shown in FIG. 19, the current limiting resistor R1 and the rotation direction control circuit 50 are connected between the switch control circuit 30 and the control electrode of the controllable bidirectional alternate current switch 26, and the anode of the diode D1 functions as the output terminal of the switch control circuit. If the switch control circuit shown in FIG. 17 or FIG. 18 is applied to the motor driving circuit shown in FIG. 19, the current limiting resistor R1 still needs to be connected between the rotation direction control circuit 50 and the control electrode of the controllable bidirectional alternate current switch 26. Specifically, the following table 3 shows controlling forward and negative rotation of the motor based on the rotation direction set of the motor, the magnetic pole position of the rotor and polarity of the power supply.

TABLE 3

| | output | | output | | | |
|---|---|---|---|---|---|---|
| | terminal | | terminal | rotation | | |
| magnetic | H1 | | of the | direction | | rotation |
| pole | of the | | switch | control circuit | | direction |
| position | hall | alternate | control | control | output | of the |
| of the rotor | sensor | current | circuit | signal | terminal | motor |
| N | 1 | positive | 1 | 0 | 1 | CCW |
| | | half-period | | | | |
| S | 0 | negative | 0 | | 0 | CCW |
| | | half-period | | | | |
| N | 1 | negative | 1 | | 1 | maintain |
| | | half-period | | | | rotating due |
| | | | | | | to inertia |
| S | 0 | positive | 0 | | 0 | maintain |
| | | half-period | | | | rotating due |
| | | | | | | to inertia |
| N | 1 | negative | 1 | 1 | 0 | CW |
| | | half-period | | | | |
| S | 0 | positive | 0 | | 1 | CW |
| | | half-period | | | | |
| N | 1 | positive | 1 | | 0 | maintain |
| | | half-period | | | | rotating due |
| | | | | | | to inertia |
| S | 0 | negative | 0 | | 1 | maintain |
| | | half-period | | | | rotating due |
| | | | | | | to inertia |

Now it is illustrated by assuming that the motor rotates forwardly. It is assumed that the rotation direction set signal CTRL outputs a logic high level “1”. When the motor starts and if a magnetic pole position of the rotor sensed by the hall sensor 22 indicates an N pole, the hall sensor 22 outputs a logic high level “1” magnetic pole position signal, the cathode of the diode D1 of the switch control circuit 30 receives the logic high level, the triode Q1 is turned on, the switch control circuit 30 outputs a logic high level, and the rotation direction control circuit 50 outputs a logic low level. If the alternate current power supply is in a negative half-period when the motor starts, the controllable bidirectional alternate current switch 26 is turned on, and the rotor 11 starts to rotate in a CW manner. If the alternate current power supply is in a positive half-period when the motor starts, the rotation direction control circuit 50 outputs a logic low level, hence no current flows through the rotation direction control circuit and the control electrode G of the controllable bidirectional alternate current switch 26, the controllable bidirectional alternate current switch 26 is turned off, and the rotor 11 does not rotate.

If the a rotor magnetic pole detected by the hall sensor 22 is an S pole, a logic low level “0” magnetic pole position signal is outputted, the cathode of the diode D1 of the switch control circuit 30 receives the logic low level, the triode Q1 is turned off, the switch control circuit 30 outputs a logic low level, and the rotation direction control circuit 50 outputs a logic high level. If the alternate current power supply is in a positive half-period when the motor starts, the controllable bidirectional alternate current switch 26 is turned on, and the rotor 11 starts to rotate in a CW manner. If the alternate current power supply is in a negative half-period when the motor starts, the controllable bidirectional alternate current switch 26 is turned off, and the rotor 11 does not rotate.

If the motor is pre-controlled to rotate reversely, i.e., rotating in a CCW manner, the rotation direction set signal CTRL is controlled to output a logic low level “0”. If a magnetic pole position of the rotor sensed by the hall sensor 22 indicates an N pole, the output terminal H1 of the hall sensor 22 outputs a logic high level “1” magnetic pole position signal, the switch control circuit outputs a logic high level, and the rotation direction control circuit outputs a logic high level. If the alternate current power supply is in a positive half-period when the motor starts, the controllable bidirectional alternate current switch 26 is turned on, and the rotor 11 starts to rotate in a CCW manner. If the alternate current power supply is in a negative half-period when the motor starts, the controllable bidirectional alternate current switch 26 is turned off, and the rotor 11 does not rotate.

If the magnetic pole position of the rotor sensed by the hall sensor 22 indicates an S pole, the output terminal H1 of the hall sensor 22 outputs a logic low level “0” magnetic pole position signal, the switch control circuit 30 outputs a logic low level, and the rotation direction control circuit 50 outputs a logic low level. If the alternate current power supply is in a negative half-period when the motor starts, the controllable bidirectional alternate current switch 26 is turned on, and the rotor 11 rotates in a CCW manner. If the alternate current power supply is in a positive half-period when the motor starts, the controllable bidirectional alternate current switch 26 is turned off, and the rotor 11 does not rotate.

The motor according the present disclosure can applied to drive devices for example an automobile window and an office or household shutter. The motor of the present disclosure may be a permanent magnet alternate current motor, for example a permanent magnet synchronous motor and a permanent magnet BLDC motor. The motor of the present disclosure is preferably a single phase permanent magnet alternate current motor, for example a single phase permanent magnet synchronous motor and a single phase permanent magnet BLDC motor. When the motor is the permanent magnet synchronous motor, the external alternate current power supply is a mains power supply. When the motor is the permanent magnet BLDC motor, the external alternate current power supply is an alternate current power supply outputted by an inverter.

The motor driving circuit may be integrated and packaged in an integrated circuit. For example, the motor driving circuit may be implemented as an ASIC single chip, thereby reducing a cost of the circuit and improve reliability of the circuit. In other embodiments, all or a part of the rectifier 28, the detection circuit 20, the rotation direction control circuit 50 and the switch control circuit 30 may be integrated in the integrated circuit. For example, only the rotation direction control circuit 50, the detection circuit 20 and the switch control circuit 30 are integrated in the integrated circuit, while the rectifier 28, the controllable bidirectional alternate current switch 26 and the resistor R0 functioning as a voltage dropping unit are arranged outside the integrated circuit.

An integrated circuit for driving a motor is further provided according to a preferred embodiment of the present disclosure. The integrated circuit includes a housing, multiple pins extending from the housing, a semiconductor substrate and a rotation direction control circuit 50 and a switch control circuit 30 arranged on the semiconductor substrate. The rotation direction control circuit 50 and the switch control circuit 30 are packaged within the housing. In other embodiments, the detection circuit 20 for detecting a magnetic pole position of the rotor of the motor may be further integrated on the semiconductor substrate. In other embodiments, the rectifier 28 and/or the controllable bidirectional alternate current switch 26 may be further integrated on the semiconductor substrate. In another embodiment, a second semiconductor substrate may be provided in the housing, and the controllable bidirectional alternate current switch is arranged on the second semiconductor substrate.

For example, the whole motor driving circuit may be arranged on a printed circuit board as a discrete component, according to the design requirement.

The rotation direction control circuit and the switch control circuit form a control circuit; the control circuit operates in a first state or a second state according to a magnetic pole position signal, where the first state can be a state in which a load current flows out from the controllable bidirectional alternate current switch via the control electrode of the controllable bidirectional alternate current switch and the second state can be to a state in which a load current flows into the controllable bidirectional alternate current switch via the control electrode of the controllable bidirectional alternate current switch; and switch, based on the rotation direction set of the motor, correspondences between the magnetic pole position signal and both the first state and the second state, to control the motor to rotate in a certain direction or in a direction opposite to the certain direction.

The embodiments described above are the preferred embodiments of the present disclosure, and are not intended to limit the present disclosure. Any changes, equivalent substitutions and improvements made within the spirit and principles of the present disclosure fall within the protection scope of the present disclosure.

1. A motor driving circuit for driving a motor, comprising:
a controllable bidirectional alternate current switch connected in series to a winding of the motor between two terminals of an alternate current power supply;
a detection circuit configured to detect a magnetic pole position of a rotor of the motor and output a magnetic pole position signal; and
a switch state of the controllable bidirectional alternate current switch is controlled to determine a rotation direction of the motor according to a control signal and polarity of the alternate power supply.

2. The motor driving circuit according to claim 1, further comprising a rotation direction control circuit configured to selectively output the magnetic pole position signal outputted by the detection circuit or an inverted signal by inverting the magnetic pole position signal to a switch control circuit according to a rotation direction set of the motor; and
the switch control circuit outputs the control signal according to the signal outputted by the rotation direction control circuit is the control signal.

3. The motor driving circuit according to claim 1, further comprising a switch control circuit to output a switch signal according to the magnetic pole position signal and the polarity information of the alternate current power supply; and
a rotation direction control circuit selectively output the switch signal or a inverting switch signal by inverting the switch signal, wherein the switch signal or the inverting switch signal is the control signal.

4. The motor driving circuit according to claim 2, wherein the switch control circuit is configured to only turn on the controllable bidirectional alternate current switch when the alternate current power supply is in a positive half-period and the rotation direction control circuit outputs a first signal or the alternate current power supply is in a negative half-period and the rotation direction control circuit outputs a second signal.

5. The motor driving circuit according to claim 2, wherein the controllable bidirectional alternate current switch is a TRIAC, a first anode and a second anode of the TRIAC are connected to the alternate current power supply and a stator winding respectively, and a control electrode of the TRIAC is connected to the switch control circuit.

6. The motor driving circuit according to claim 2, wherein when the motor rotates in a certain direction, the rotation direction control circuit outputs the magnetic pole position signal outputted by the detection circuit to the switch control circuit; and when the motor rotates in a direction opposite to the certain direction, the rotation direction control circuit inverts the magnetic pole position signal outputted by the detection circuit and then outputs the inverted signal to the switch control circuit.

7. The motor driving circuit according to claim 2, further comprising a rectifier configured to provide a direct current voltage to at least the detection circuit.

8. The motor driving circuit according to claim 2, wherein the detection circuit is a hall sensor comprising a power supply terminal, a ground terminal and an output terminal, the power supply terminal of the hall sensor is connected to a first output terminal of a rectifier, the ground terminal of the hall sensor is connected to a second output terminal of the rectifier, and the output terminal of the hall sensor is connected to an input terminal of the rotation direction control circuit.

9. The motor driving circuit according to claim 1, wherein the rotation direction control circuit comprises a multiplexer and an inverter; the invert is configured to invert the magnetic pole position signal.

10. An integrated circuit for driving a motor, wherein the integrated circuit comprises a detection circuit;
the detection circuit is configured to detect a magnetic pole position of a rotor of the motor and outputs a magnetic pole position signal;
a controllable bidirectional alternate current switch arranged out of the integrated circuit and connected in series to a winding of the motor, and a switch state of the controllable bidirectional alternate current switch is controlled to determine a rotation direction of the motor according to a control signal outputted by the integrated circuit and polarity of an alternate power supply which supply power for the motor.

11. The integrated circuit according to claim 9, further comprising a rotation direction control circuit configured to selectively output the magnetic pole position signal outputted by the detection circuit or an inverted signal by inverting the magnetic pole position signal to a switch control circuit according to a rotation direction set of the motor; and
a switch control circuit outputs the control signal according to the signal outputted by the rotation direction control circuit is the control signal.

12. The integrated circuit according to claim 9, further comprising a switch control circuit to output a switch signal according to the magnetic pole position signal and the polarity information of the alternate current power supply; and a rotation direction control circuit selectively output the switch signal or a inverting switch signal by inverting the switch signal, wherein the switch signal or the inverting switch signal is the control signal.

13. The integrated circuit according to claim 12, wherein the switch control circuit is configured to only turn on the controllable bidirectional alternate current switch when the alternate current power supply is in a positive half-period and the rotation direction control circuit outputs a first signal or the alternate current power supply is in a negative half-period and the rotation direction control circuit outputs a second signal.

14. The integrated circuit according to claim 12, wherein the controllable bidirectional alternate current switch is a TRIAC, a first anode and a second anode of the TRIAC are connected to the alternate current power supply and a stator winding respectively, and a control electrode of the TRIAC is connected to the switch control circuit.

15. The integrated circuit according to claim 12, wherein when the motor rotates in a certain direction, the rotation direction control circuit outputs the magnetic pole position signal outputted by the detection circuit to the switch control circuit; and when the motor rotates in a direction opposite to the certain direction, the rotation direction control circuit inverts the magnetic pole position signal outputted by the detection circuit and then outputs the inverted signal to the switch control circuit.

16. The integrated circuit according to claim 12, wherein a rectifier is integrated in the integrated circuit and configured to provide a direct current voltage to at least the detection circuit.

17. The integrated circuit according to claim 12, wherein the detection circuit is a hall sensor comprising a power supply terminal, a ground terminal and an output terminal, the power supply terminal of the hall sensor is connected to a first output terminal of a rectifier, the ground terminal of the hall sensor is connected to a second output terminal of the rectifier, and the output terminal of the hall sensor is connected to an input terminal of the rotation direction control circuit.

18. A motor, comprising a stator, a rotor and a motor driving circuit, wherein the motor driving circuit comprises
a controllable bidirectional alternate current switch connected in series to a winding of the motor between two terminals of an alternate current power supply;
a detection circuit configured to detect a magnetic pole position of a rotor of the motor and output a magnetic pole position signal; and
a switch state of the controllable bidirectional alternate current switch is controlled to determine a rotation direction of the motor according to a control signal and polarity of the alternate power supply.

19. The motor according to claim 18, wherein the rotor of the motor is a permanent magnet rotor; and the stator comprises a stator core and a stator winding wound on the stator core.

20. The motor according to claim 18, wherein the motor is a single phase permanent magnet alternate current motor.
